(19) United States
(12) Patent Application Publication
(10) Pub. No.: US 2025/0158721 A1
(43) Pub. Date: May 15, 2025

(54) SIGNAL PROCESSING METHOD, SIGNAL PROCESSING APPARATUS AND COMMUNICATION SYSTEM

(71) Applicant: NIPPON TELEGRAPH AND TELEPHONE CORPORATION, Tokyo (JP)

(72) Inventors: Masanori NAKAMURA, Musashino-shi (JP); Takayuki KOBAYASHI, Musashino-shi (JP); Fukutaro HAMAOKA, Musashino-shi (JP); Yutaka MIYAMOTO, Musashino-shi (JP)

(73) Assignee: NIPPON TELEGRAPH AND TELEPHONE CORPORATION, Tokyo (JP)

(21) Appl. No.: 18/834,073

(22) PCT Filed: Feb. 10, 2022
(86) PCT No.: PCT/JP2022/005466

§ 371 Date: Jul. 29, 2024

(51) Int. Cl. H04B 10/61; H04J 14/06

(52) U.S. Cl. CPC H04B 10/6166; H04J 14/06

(57) ABSTRACT

A signal processing method includes performing first equalization processing for converting a real component and an imaginary component of each polarization of a polarization multiplexed reception signal into a frequency domain signal, receiving, as input signals, a frequency domain signal of the real component and a frequency domain signal of the imaginary component of each polarization, and a signal obtained by performing frequency inversion on the frequency domain signal of the real component and the frequency domain signal of the imaginary component of each polarization and performing complex conjugate, performing, for each polarization, multiplying the real component and the imaginary component of each polarization by a complex transfer function, adding results, and performing inverse transform from the frequency domain signal to a time domain signal, performing second equalization processing for performing frequency inversion of the real component of each polarization included in the input signal, performing frequency inversion of a real component signal and an imaginary component subjected to complex conjugate, multiplying the imaginary component signals subjected to complex conjugation by a complex transfer function, adding results of the multiplications, and performing inverse transform from a frequency domain signal to a time domain signal, and adding or subtracting a transmission data bias correction signal to or from a signal obtained by adding a first addition signal to a second addition signal.

### TECHNICAL FIELD

The present invention relates to a signal processing method, a signal processing apparatus, and a communication system.

### BACKGROUND ART

Digital coherent transmission requires not only compensation for waveform distortion occurring in an optical fiber transmission line, but also adaptive compensation for device imperfections in an optical transceiver. In an adaptive equivalent circuit used in general signal processing, it is necessary for compensation for waveform distortion occurring in a transmission path to be mainly performed, and for compensation for device imperfections in a transmitter and a receiver to be separately performed in subsequent signal processing. Therefore, there is a technology that collectively compensates for device imperfections in the transmitter and receiver (see, for example, PTL 1 and NPL 1).

### CITATION LIST

### Patent Literature

[PTL 1] Japanese Patent Application Publication No. 2020-141294

### Non Patent Literature

[NPL 1] Takayuki Kobayashi, et al., “35-Tb/s C-Band Transmission Over 800 km Employing 1-Tb/s PS-64QAM Signals Enhanced by Complex 8×2 MIMO Equalizer,” Optical Fiber Communication Conference Postdeadline Papers 2019, Th4B.2

### SUMMARY OF INVENTION

### Technical Problem

An adaptive equalization circuit of PTL 1 and NPL 1 has a different configuration from a 2×2 multiple input multiple output (MIMO) adaptive equalization circuit with complex number input and complex number output that is generally used in optical communication of the related art. In the adaptive equalization circuits of PTL 1 and NPL 1, there is no commonality or compatibility in generated tap coefficients, or the like, and a total number of taps increases. Therefore, there is a problem in that an amount of calculation increases exponentially as the number of taps increases.

In view of the above circumstances, an object of the present invention is to provide a technology through which it is possible to perform equalization processing while reducing an amount of calculation in digital coherent optical transmission.

### Means to Solve the Problem

One aspect of the present invention is a signal processing method including: a conversion step of converting a real component and an imaginary component of each polarization of a polarization multiplexed reception signal into a frequency domain signal; a signal input step of receiving, as input signals, the frequency domain signal of the real component and the frequency domain signal of the imaginary component of each polarization, and a post-conversion frequency domain signal obtained by performing frequency inversion on a frequency axis on the frequency domain signal of the real component and the frequency domain signal of the imaginary component of each polarization and performing complex conjugation; an equalization step of performing, for each polarization, first equalization processing for multiplying the frequency domain signal of the real component and the frequency domain signal of the imaginary component of each polarization included in the input signal by a complex transfer function, adding results, and performing an inverse transform from the frequency domain signal to the time domain signal, and second equalization processing for multiplying the post-conversion frequency domain signal of the real component and the post-conversion frequency domain signal of the imaginary component of each polarization included in the input signal by a complex transfer function, adding results, and performing an inverse transform from the frequency domain signal to the time domain signal; and a compensation step of, for each polarization, performing phase rotation for frequency offset compensation on the time domain signal converted in the first equalization processing to generate a first addition signal, performing phase rotation opposite to the phase rotation for frequency offset compensation on the time domain signal converted in the second equalization processing to generate a second addition signal, and adding or subtracting a transmitted data bias correction signal to or from a signal obtained by adding the first addition signal to the second addition signal.

One aspect of the present invention is a signal processing method including: an addition processing step of performing imaginary unit multiplication processing for multiplying the imaginary component of each polarization of the polarization multiplexed reception signal by an imaginary unit j, and then performing addition processing of adding the imaginary component multiplied by the imaginary unit j to the real component of each polarization of the polarization multiplexed reception signal; a conversion step of converting a signal after processing for adding the imaginary component multiplied by the imaginary unit j to the real component into a frequency domain signal; a signal input step of receiving, as input signals, the calculated frequency domain signal after the calculation has been performed on the frequency domain signal of each polarization, and a post-conversion calculated frequency domain signal after calculation is performed on a post-conversion frequency domain signal obtained by performing frequency inversion on a frequency axis on the frequency domain signal of each polarization and performing complex conjugation; an equalization step of performing, for each polarization, first equalization processing for multiplying the calculated frequency domain signal of the real component and the calculated frequency domain signal of the imaginary component of each polarization included in the input signal by a complex transfer function, adding results, and performing an inverse transform from the frequency domain signal to the time domain signal, and second equalization processing for multiplying the post-conversion calculated frequency domain signal of the real component and the post-conversion calculated frequency domain signal of the imaginary component of each polarization included in the input signal by a complex transfer function, adding results, and performing an inverse transform from the frequency domain signal to the time domain signal; and a compensation step of, for each polarization, performing phase rotation for frequency offset compensation on the time domain signal converted in the first equalization processing to generate a first addition signal, performing phase rotation opposite to the phase rotation for frequency offset compensation on the time domain signal converted in the second equalization processing to generate a second addition signal, and adding or subtracting a transmitted data bias correction signal to or from a signal obtained by adding the first addition signal to the second addition signal.

One aspect of the present invention is a signal processing apparatus including: a frequency conversion unit configured to convert a real component and an imaginary component of each polarization of a polarization multiplexed reception signal into a frequency domain signal; a signal input unit configured to receive, as input signals, the frequency domain signal of the real component and the frequency domain signal of the imaginary component of each polarization, and a post-conversion frequency domain signal obtained by performing frequency inversion on a frequency axis on the frequency domain signal of the real component and the frequency domain signal of the imaginary component of each polarization and performing complex conjugation; an equalization unit configured to perform, for each polarization, first equalization processing for multiplying the frequency domain signal of the real component and the frequency domain signal of the imaginary component of each polarization included in the input signal by a complex transfer function, adding results, and performing an inverse transform from the frequency domain signal to the time domain signal, and second equalization processing for multiplying the post-conversion frequency domain signal of the real component and the post-conversion frequency domain signal of the imaginary component of each polarization included in the input signal by a complex transfer function, adding results, and performing an inverse transform from the frequency domain signal to the time domain signal; and a compensation unit configured to, for each polarization, perform phase rotation for frequency offset compensation on the time domain signal converted in the first equalization processing to generate a first addition signal, perform phase rotation opposite to the phase rotation for frequency offset compensation on the time domain signal converted in the second equalization processing to generate a second addition signal, and add or subtract a transmitted data bias correction signal to or from a signal obtained by adding the first addition signal to the second addition signal.

One aspect of the present invention is a signal processing apparatus including: an addition unit configured to perform imaginary unit multiplication processing for multiplying the imaginary component of each polarization of the polarization multiplexed reception signal by an imaginary unit j, and then performing addition processing of adding the imaginary component multiplied by the imaginary unit j to the real component of each polarization of the polarization multiplexed reception signal; a frequency conversion unit configured to convert a signal after processing for adding the imaginary component multiplied by the imaginary unit j to the real component into a frequency domain signal; a signal input unit configured to receive, as input signals, the calculated frequency domain signal after the calculation has been performed on the frequency domain signal of each polarization, and a post-conversion calculated frequency domain signal after calculation is performed on a post-conversion frequency domain signal obtained by performing frequency inversion on a frequency axis on the frequency domain signal of each polarization and performing complex conjugation; an equalization unit configured to perform, for each polarization, first equalization processing for multiplying the calculated frequency domain signal of the real component and the calculated frequency domain signal of the imaginary component of each polarization included in the input signal by a complex transfer function, adding results, and performing an inverse transform from the frequency domain signal to the time domain signal, and second equalization processing for multiplying the post-conversion calculated frequency domain signal of the real component and the post-conversion calculated frequency domain signal of the imaginary component of each polarization included in the input signal by a complex transfer function, adding results, and performing an inverse transform from the frequency domain signal to the time domain signal; and a compensation unit configured to, for each polarization, perform phase rotation for frequency offset compensation on the time domain signal converted in the first equalization processing to generate a first addition signal, perform phase rotation opposite to the phase rotation for frequency offset compensation on the time domain signal converted in the second equalization processing to generate a second addition signal, and add or subtract a transmitted data bias correction signal to or from a signal obtained by adding the first addition signal to the second addition signal.

One aspect of the present invention is a communication system including a transmitter that transmits a polarization-multiplexed signal subjected to polarization multiplexing, and a receiver having the above signal processing apparatus.

### Advantageous Effects of Invention

According to the present invention, it is possible to perform equalization processing while reducing the amount of calculation in digital coherent optical transmission.

### BRIEF DESCRIPTION OF DRAWINGS

FIG. 1 is a diagram illustrating a configuration example of a digital coherent optical transmission system in a first embodiment.

FIG. 2 is a diagram illustrating an example of a configuration of a demodulated digital signal processing unit in the first embodiment.

FIG. 3 is a diagram illustrating an example of a coefficient calculation unit.

FIG. 4 is a diagram illustrating an example of the coefficient calculation unit.

FIG. 5 is a diagram illustrating an example of the coefficient calculation unit.

FIG. 6 is a diagram illustrating an example of the coefficient calculation unit.

FIG. 7 is a diagram illustrating an example of a configuration of a demodulated digital signal processing unit in a modification example of the first embodiment.

FIG. 8 is a diagram illustrating effects of the present invention.

FIG. 9 is a diagram illustrating the effects of the present invention.

FIG. 10 is a diagram illustrating an example of a configuration of a demodulated digital signal processing unit in a second embodiment.

FIG. 11 is a diagram illustrating an example of a configuration of a demodulated digital signal processing unit in a modification example of the second embodiment.

FIG. 12 is a diagram illustrating an example of a configuration of a demodulated digital signal processing unit in a third embodiment.

### DESCRIPTION OF EMBODIMENTS

Hereinafter, an embodiment of the present invention will be described with reference to the drawings.

### First Embodiment

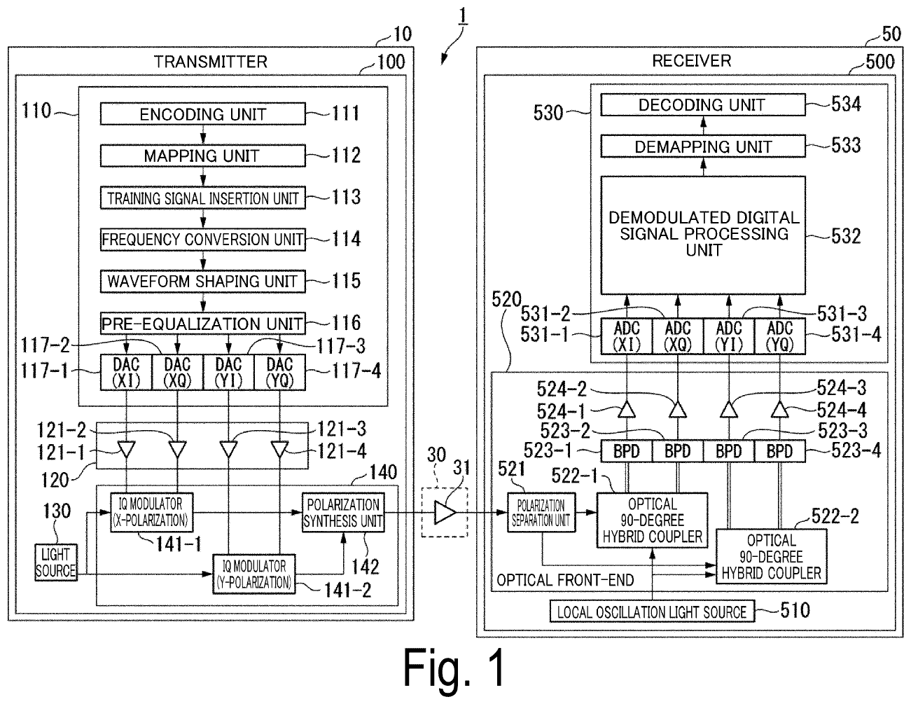

FIG. 1 is a diagram illustrating a configuration example of a digital coherent optical transmission system 1 in a first embodiment. The digital coherent optical transmission system 1 includes a transmitter 10 and a receiver 50. The transmitter 10 transmits a polarization-multiplexed signal. The receiver 50 receives the polarization-multiplexed signal from the transmitter 10.

The transmitter 10 includes at least one transmission unit 100. The transmission unit 100 outputs the polarization-multiplexed signal with a designated wavelength to the optical fiber transmission line 30. The optical fiber transmission line 30 includes an arbitrary number of optical amplifiers 31. Each optical amplifier 31 receives a polarization-multiplexed signal from the optical fiber transmission line 30 on the transmitter 10 side, amplifies the polarization-multiplexed signal, and outputs the polarization-multiplexed signal to the optical fiber transmission line 30 on the receiver 50 side. The receiver 50 includes at least one reception unit 500. The reception unit 500 receives the polarization-multiplexed signal.

First, a configuration of the transmitter 10 will be described.

The transmission unit 100 includes a digital signal processing unit 110, a modulator driver 120, a light source 130, and an integrated module 140. The digital signal processing unit 110 includes an encoding unit 111, a mapping unit 112, a training signal insertion unit 113, a frequency conversion unit 114, a waveform shaping unit 115, a pre-equalization unit 116, and digital-to-analog converters (DAC) 117-1 to 117-4.

The encoding unit 111 outputs a transmission signal obtained by performing forward error correction (FEC) encoding on a transmission bit string.

The mapping unit 112 maps the transmission signal output from encoding unit 111 with symbols.

The training signal insertion unit 113 inserts a known training signal into the transmission signal symbol-mapped by the mapping unit 112.

The frequency conversion unit 114 performs upsampling by changing the sampling frequency for the transmission signal into which the training signal has been inserted.

The waveform shaping unit 115 limits a band of the sampled transmission signal.

The pre-equalization unit 116 compensates for waveform distortion of the transmission signal band-limited by the waveform shaping unit 115, and outputs the transmission signal to the DACs 117-1 to 117-4.

The DAC 117-1 converts the I (in-phase) component of the X-polarization of the transmission signal input from the pre-equalization unit 116 from a digital signal to an analog signal, and outputs the analog signal to the modulator driver 120. The DAC 117-2 converts the Q (orthogonal) component of the X-polarization of the transmission signal input from the pre-equalization unit 116 from a digital signal to an analog signal, and outputs it to the modulator driver 120. The DAC 117-3 converts the Y-polarization I component of the transmission signal input from the pre-equalization unit 116 from a digital signal to an analog signal, and outputs the analog signal to the modulator driver 120. The DAC 117-4 converts the Q component of the Y polarization of the transmission signal input from the pre-equalization unit 116 from a digital signal to an analog signal, and outputs the analog signal to the modulator driver 120.

The modulator driver 120 includes amplifiers 121-1 to 121-4. The amplifier 121-i (i is an integer between 1 and 4) amplifies the analog signal output from the DAC 117-i, and drives the modulator of the integrated module 140 using the amplified analog signal.

The light source 130 is, for example, a semiconductor laser (LD). The light source 130 outputs light with a designated wavelength.

The integrated module 140 includes IQ modulators 141-1 and 141-2 and a polarization synthesis unit 142. The IQ modulator 141-1 modulates an optical signal output from the light source 130 on the basis of the I component of the X-polarization output from the amplifier 121-1 and the Q component of the X-polarization output from the amplifier 121-2 to generate an X-polarization optical signal. The IQ modulator 141-2 modulates an optical signal output from the light source 130 on the basis of the I component of the X-polarization output from the amplifier 121-3 and the Q component of the Y-polarization output from the amplifier 121-4, to generate a Y-polarization optical signal. The polarization synthesis unit 142 polarization-multiplexes the X-polarization optical signal generated by the IQ modulator 141-1 and the Y-polarization optical signal generated by the IQ modulator 141-2 to generate a polarization-multiplexed signal. The polarization synthesis unit 142 outputs the generated polarization-multiplexed signal to the optical fiber transmission line 30.

Next, a configuration of the receiver 50 will be described.

The reception unit 500 includes a local oscillation light source 510, an optical front-end 520, and a digital signal processing unit 530. The local oscillation light source 510 is, for example, an LD. The local oscillation light source 510 outputs local oscillator light (LO).

The optical front-end 520 converts the optical signal into an electrical signal while maintaining a phase and amplitude of a polarization multiplexed phase modulated signal. The optical front-end 520 includes a polarization separation unit 521, optical 90-degree hybrid couplers 522-1 and 522-2, balanced photo diodes (BPDs) 523-1 to 523-4, and amplifiers 524-1 to 524-4.

The polarization separation unit 521 separates the input optical signal into an X-polarization optical signal and a Y-polarization optical signal. The polarization separation unit 521 outputs the X-polarization optical signal to the optical 90-degree hybrid coupler 522-1, and outputs the Y-polarization optical signal to the optical 90-degree hybrid coupler 522-2.

The optical 90-degree hybrid coupler 522-1 causes the X-polarization optical signal to interfere with the local oscillation light output from the local oscillation light source 510, and extracts an I-component optical signal and Q-component optical signal of a received optical electric field. The optical 90-degree hybrid coupler 522-1 outputs the extracted I-component optical signal and Q-component optical signal of the X polarization to the BPDs 523-1 and 523-2.

The optical 90-degree hybrid coupler 522-2 causes the Y-polarization optical signal to interfere with the local oscillation light output from the local oscillation light source 510, and extracts the I component and Q component of the received optical electric field. The optical 90-degree hybrid coupler 522-2 outputs the extracted I component and Q component of the Y polarization to the BPD 523-3 and BPD 523-4.

The BPDs 523-1 to 523-4 are differential input type photoelectric converters. The BPD 523-i outputs the difference value between the photocurrents generated in the two photodiodes with the same characteristics to the amplifier 524-i. The BPD 523-1 converts the I component of the reception signal of the X-polarization into an electrical signal and outputs the electrical signal to the amplifier 524-1. The BPD 523-2 converts the Q component of the reception signal of the X-polarization into an electrical signal and outputs the electrical signal to the amplifier 524-2. The BPD 523-3 converts the I component of the reception signal of the Y-polarization into an electrical signal and outputs the electrical signal to the amplifier 524-3. The BPD 523-4 converts the Q component of the reception signal of the Y-polarization into an electrical signal and outputs the electrical signal to the amplifier 524-4. The amplifier 524-i (i is an integer between 1 and 4) amplifies the electrical signal output from the BPD 523-i and outputs the electrical signal to the digital signal processing unit 530.

The digital signal processing unit 530 includes analog-to-digital converters (ADC) 531-1 to 531-4, a demodulated digital signal processing unit 532, a demapping unit 533, and a decoding unit 534.

The ADC 531-i (i is an integer between 1 and 4) converts the electrical signal output from amplifier 524-i from an analog signal to a digital signal, and outputs the digital signal to the demodulated digital signal processing unit 532.

The demodulated digital signal processing unit 532 receives the I component of the reception signal of the X-polarization from the ADC 531-1, the Q component of the reception signal of the X-polarization from the ADC 531-2, the I component of the reception signal of the Y-polarization from the ADC 531-3, and the Q component of the reception signal of the Y-polarization from the ADC 531-4. The demodulated digital signal processing unit 532 performs signal processing such as at least equalization processing, frequency offset and phase noise compensation on each input signal. The demodulated digital signal processing unit 532 performs signal processing such as frequency characteristic compensation and chromatic dispersion compensation as necessary.

Whether or not the demodulated digital signal processing unit 532 performs the signal processing such as frequency characteristic compensation and chromatic dispersion compensation depends on the configuration of the demodulated digital signal processing unit 532. Therefore, this will be described in detail when the configuration of the demodulated digital signal processing unit 532 is described. The demodulated digital signal processing unit 532 is an aspect of a signal processing apparatus.

The demapping unit 533 determines the symbols of the reception signal output by the demodulated digital signal processing unit 532, and converts the determined symbols into binary data.

The decoding unit 534 performs error correction decoding processing such as FEC on the binary data demapped by the demapping unit 533 to obtain a received bit string.

Although the above embodiment describes an example of a single optical fiber transmission line, the same applies to spatially multiplexed transmission systems (for example, multi-core fiber, multi-mode fiber, and free space transmission).

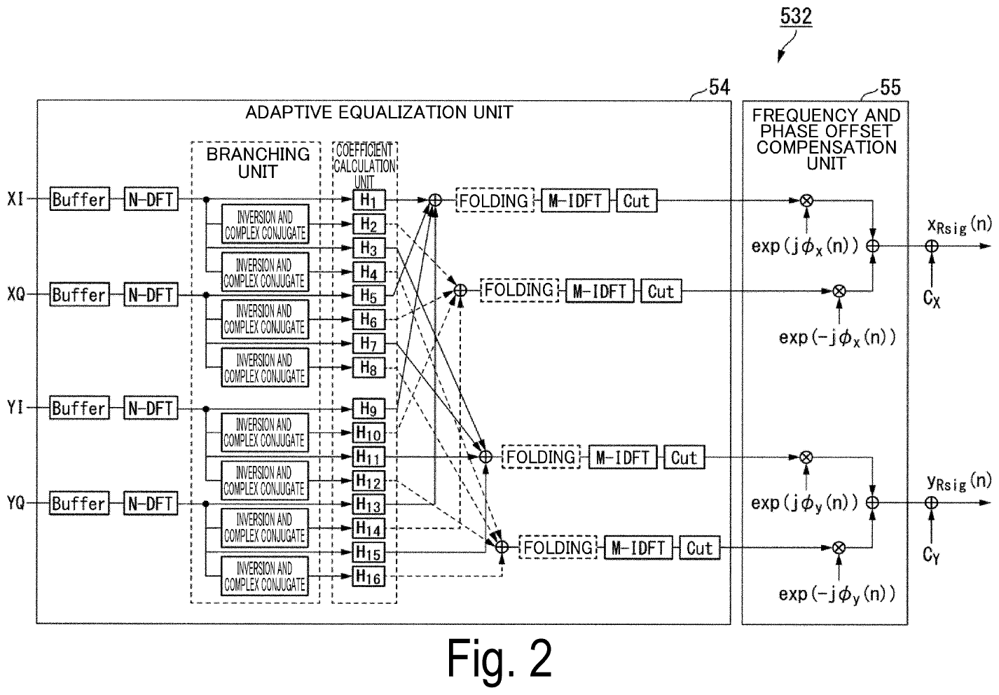

Next, a configuration of the demodulated digital signal processing unit 532 will be described. FIG. 2 is a diagram illustrating an example of a configuration of the demodulated digital signal processing unit 532 in the first embodiment. The demodulated digital signal processing unit 532 illustrated in FIG. 2 performs signal processing such as equalization processing, frequency offset, and phase noise compensation. The demodulated digital signal processing unit 532 illustrated in FIG. 2 does not perform the signal processing such as frequency characteristic compensation and chromatic dispersion compensation.

The demodulated digital signal processing unit 532 includes an adaptive equalization unit 54 and a frequency and phase offset compensation unit 55. The adaptive equalization unit 54 adaptively performs equalization processing on each input signal. The frequency and phase offset compensation unit 55 performs processing such as frequency offset and phase noise compensation on the reception signal subjected to the equalization processing by the adaptive equalization unit 54.

Next, an operation of the demodulated digital signal processing unit 532 will be described. The adaptive equalization unit 54 of the demodulated digital signal processing unit 532 receives the real component XI and the imaginary component XQ of the reception signal of the X-polarization converted into digital signals by the ADCs 531-1 to 531-4, and the real component YI and the imaginary component YQ of the reception signal of the Y-polarization. The adaptive equalization unit 54 stores each of the input real component XI, imaginary component XQ, real component YI, and imaginary component YQ in a corresponding buffer. The buffer corresponds to the buffer used in an overlap save method described in Reference 1 below.
(Reference 1: JOHN J. SHYNK, “Frequency-Domain and Multirate Adaptive Filtering”, January 1992.)

The adaptive equalization unit 54 performs discrete Fourier transform or fast Fourier transform of N (N is a natural number) points on each of the real component XI, the imaginary component XQ, the real component YI, and the imaginary component YQ stored in the buffer (corresponding to “N-DFT” illustrated in FIG. 2). Accordingly, the adaptive equalization unit 54 converts the real component and imaginary component of each polarization into a frequency domain signal. That is, the adaptive equalization unit 54 generates the frequency domain signal of the real component XI, the frequency domain signal of the imaginary component XQ, the frequency domain signal of the real component YI, and the frequency domain signal of the imaginary component YQ. In the following description, a case in which the number of N points is 256 will be described as an example when the description is given using numerical values.

The frequency domain signal of the real component XI, the frequency domain signal of the imaginary component XQ, the frequency domain signal of the real component YI, and the frequency domain signal of the imaginary component YQ generated by the adaptive equalization unit 54 are each branched into four by the branching unit. Among the four branched frequency domain signals, two frequency domain signals are input to the coefficient calculation unit as they are, and the remaining two frequency domain signals are converted into frequency domain signals that are inverted and complex conjugated and then input to the coefficient calculation unit.

For example, when the frequency domain signal of the real component XI is taken as an example, the frequency domain signal of the real component XI is branched into four by the branching unit, and two of the four branched frequency domain signals of the real component XI are input to the coefficient calculation unit as they are, and the remaining two frequency domain signals are inverted and converted into a frequency domain signal subjected to inversion and complex conjugation by the inversion and complex conjugation unit, and then input to the coefficient calculation unit.

Here, the frequency domain signal subjected to the inversion and complex conjugation is a signal obtained by inverting the frequency domain signal with respect to a direct current (DC: this is a DC component and has a frequency of 0) in the frequency domain in order to realize, in the frequency domain, an equivalent operation to the generation of a complex conjugation signal in the time domain, and performing complex conjugate. Considering a signal X(f) in a certain frequency domain, the inversion and complex conjugation unit outputs a signal X\(−f). Hereinafter, the frequency domain signal of the real component converted by the inversion and complex conjugation unit will be referred to as a “real component inverted complex conjugation signal”, and the frequency domain signal of the imaginary component will be referred to as an “imaginary component inverted complex conjugation signal”.

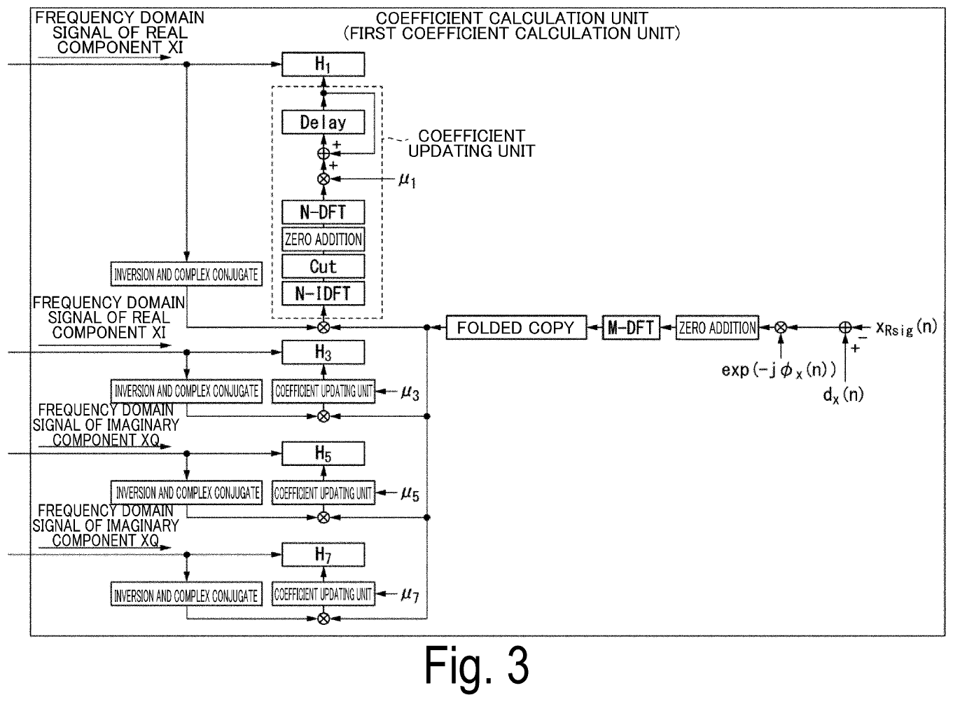

The coefficient calculation unit multiplies the input signal by the complex transfer function of the impulse responses H₁ to H₁₆. Although FIG. 2 illustrates only the values of the impulse responses H₁ to H₁₆ as a coefficient calculation unit, a specific configuration of the coefficient calculation unit will be described with reference to FIGS. 3 to 6.

The adaptive equalization unit 54 adds a real component XI(f) multiplied by a complex transfer function of an impulse response H₁, an imaginary component XQ(f) multiplied by the complex transfer function of the impulse response H₅, a real component YI(f) multiplied by the complex transfer function of the impulse response H₉, and an imaginary component YQ(f) multiplied by the complex transfer function of the impulse response H₁₃ to generate an addition signal. Thereafter, the addition signal generated by the adaptive equalization unit 54 is subjected to folding processing in the frequency domain. The folding processing is processing for adding a frequency component having an absolute value greater than a frequency (Nyquist frequency) that is half a symbol rate by folding a Nyquist frequency in a line-symmetric manner. This processing corresponds to downsampling processing in the time domain.

The adaptive equalization unit 54 performs inverse discrete Fourier transform or inverse fast Fourier transform of M (M is a natural number, N≥M) points on the addition signal subjected to the folding processing (corresponding to “M-IDFT” illustrated n FIG. 2). Accordingly, the adaptive equalization unit 54 converts the frequency domain signal into a time domain signal. Thereafter, the adaptive equalization unit 54 performs signal extraction processing using the overlap save method on the time domain signal (corresponding to “Cut” illustrated in FIG. 2).

In the following description, a case in which the number of M points is 128 will be described as an example when description is given using numerical values. When the number of M points is 128, the number of symbol points obtained by signal extraction processing in the overlap save method is 64.

In order to realize the above processing, the adaptive equalization unit 54 includes a buffer, a Fourier transform unit, a branching unit, a coefficient calculation unit, an addition unit, a folding unit, an inverse Fourier transform unit, and a cutting unit.

Although the above example illustrates a configuration in which folding, M-IDFT, and Cut processing are performed in this order, a configuration in which processing is performed in order of IDFT, Cut, and downsampling processing may be adopted.

The frequency and phase offset compensation unit 55 multiplies the addition signal cut out by the adaptive equalization unit 54 as described above by a frequency offset exp(jφₓ(n)). n represents a symbol interval.

The adaptive equalization unit 54 adds a real component inverted complex conjugation signal XI\(−f) multiplied by the complex transfer function of the impulse response H₂, an imaginary component inverted complex conjugate signal XQ\(−f) multiplied by the complex transfer function of the impulse response H₆, a real component inverted complex conjugation signal YI\(−f) multiplied by the complex transfer function of the impulse response H₁₀, and an imaginary component inverted complex conjugation signal YQ†(−f) multiplied by the complex transfer function of the impulse response H₁₄ to generate an addition signal. Thereafter, the addition signal generated by the adaptive equalization unit 54 is subjected to folding, M-IDFT, and Cut processing.

The frequency and phase offset compensation unit 55 multiplies the addition signal cut out by the adaptive equalization unit 54 as described above by a frequency offset exp(−jφₓ(n)). The frequency and phase offset compensation unit 55 adds the addition signal multiplied by the frequency offset exp(jφₓ(n)) to the addition signal multiplied by the frequency offset exp(−jφₓ(n)) to obtain the reception signal of the X-polarization component.

The demodulated digital signal processing unit 532 adds (or subtracts) a transmission data bias correction signal C_{X} for canceling a bias shift of the X polarization component to (from) the obtained reception signal of the X polarization component, and obtains a reception signal X_{Rsig}(n) of the X polarization component subjected to the distortion correction.

Meanwhile, the adaptive equalization unit 54 adds the real component XI(f) multiplied by the complex transfer function of the impulse response H₃, the imaginary component XQ(f) multiplied by the complex transfer function of the impulse response H₇, the real component YI(f) multiplied by the complex transfer function of the impulse response H₁₁, and the imaginary component YQ(f) multiplied by the complex transfer function of the impulse response His to generate an addition signal. Thereafter, the addition signal generated by the adaptive equalization unit 54 is subjected to folding, M-IDFT, and Cut processing. The frequency and phase offset compensation unit 55 multiplies the addition signal cut out by the adaptive equalization unit 54 by a frequency offset exp(jφ_{y}(n)).

The adaptive equalization unit 54 adds the real component inverted complex conjugate signal XI\(−f) multiplied by the complex transfer function of the impulse response H₄, the imaginary component inverted complex conjugate signal XQ\(−f) multiplied by the complex transfer function of the impulse response H₁₂, the real component inverted complex conjugate signal XI\(−f) multiplied by the complex transfer function of the impulse response H₁₆, and the imaginary component inverted complex conjugate signal YQ†(−f) multiplied by the complex transfer function of the impulse response H₁₄ to generate an addition signal. Thereafter, the addition signal generated by the adaptive equalization unit 54 is subjected to folding, M-IDFT, and Cut processing.

The frequency and phase offset compensation unit 55 multiplies the addition signal cut out by the adaptive equalization unit 54 as described above by a frequency offset exp(−jφ_{y}(n)). The frequency and phase offset compensation unit 55 adds the addition signal multiplied by the frequency offset exp(jφ_{y}(n)) to the addition signal multiplied by the frequency offset exp(−jφ_{y}(n)) to obtain a reception signal of a Y polarization component.

The demodulated digital signal processing unit 532 adds (or subtracts) a transmission data bias correction signal Cy for canceling a bias shift of the Y polarization component to (from) the obtained reception signal of the Y polarization component, and obtains a reception signal Y_{Rsig}(n) of the X polarization component subjected to the distortion correction.

A value of N, a value of M, the impulse responses H₁ to H₁₆, and frequency offsets exp(jφₓ(n)), exp(−jφₓ(n)), exp(jφ_{y}(n)), exp(−jφ_{y}(n)) are adaptively and dynamically changed. The receiver 50 acquires these values by using any method.

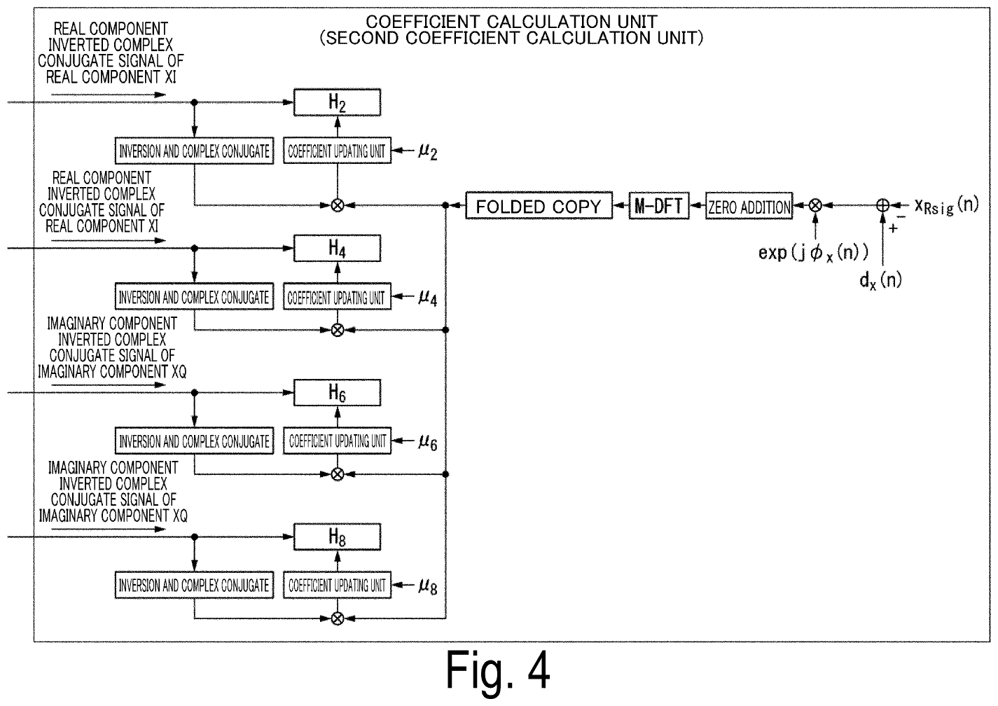

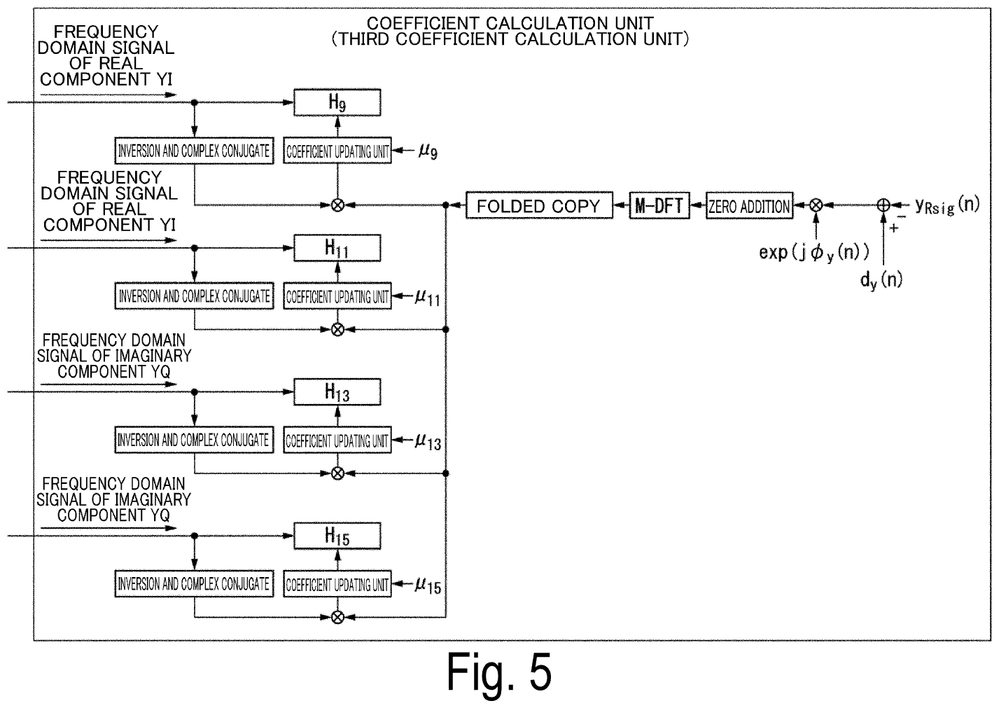

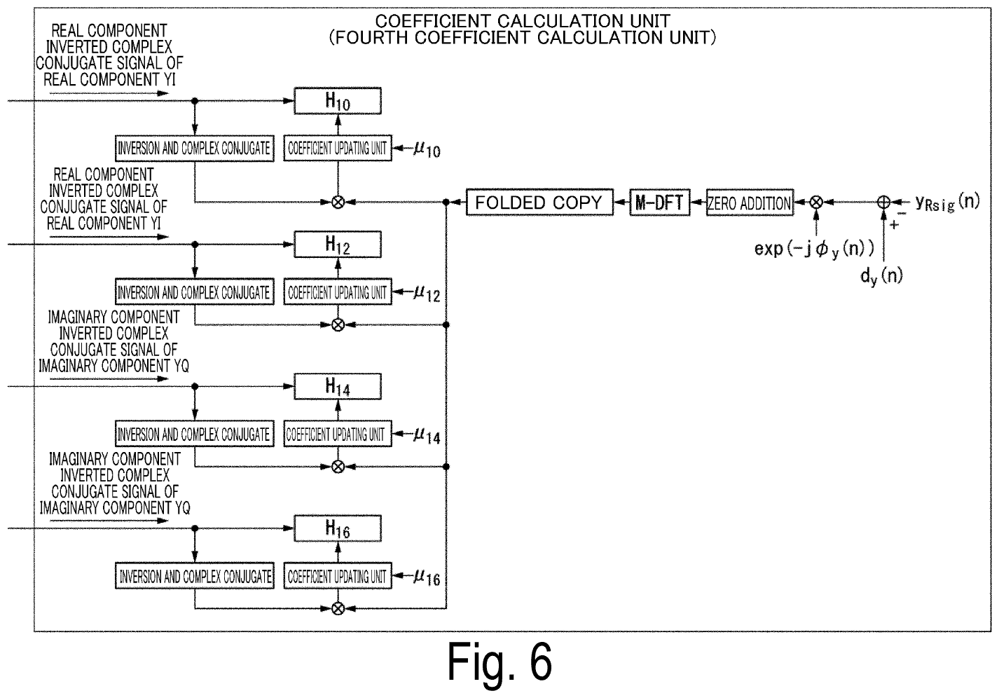

Next, a configuration and operation of the coefficient calculation unit will be described. FIGS. 3 to 6 are diagrams illustrating an example of the configuration of the coefficient calculation unit. As illustrated in FIGS. 3 to 6, the coefficient calculation unit included in the demodulated digital signal processing unit 532 includes four coefficient calculation units. The coefficient calculation unit illustrated in FIG. 3 is a functional unit that calculates impulse responses H₁, H₃, H₅, and H₇. The coefficient calculation unit illustrated in FIG. 4 is a functional unit that calculates impulse responses H₂, H₄, H₆, and H₈. The coefficient calculation unit illustrated in FIG. 5 is a functional unit that calculates impulse responses H₉, H₁, H₁₃, and H₁₅. The coefficient calculation unit illustrated in FIG. 6 is a functional unit that calculates impulse responses H₁₀, H₁₂, H₁₄, and H₁₆. The coefficient calculation unit includes a coefficient updating unit. The coefficient updating unit updates the value of the impulse response.

In the following description, the coefficient calculation unit illustrated in FIG. 3 will be referred to as a “first coefficient calculation unit”, the coefficient calculation unit illustrated in FIG. 4 will be referred to as a “second coefficient calculation unit”, the coefficient calculation unit illustrated in FIG. 5 will be referred to as a “third coefficient calculation unit,” and the coefficient calculation unit illustrated in FIG. 6 will be referred to as a “fourth coefficient calculation unit.” When the first to fourth coefficient calculation units are not particularly distinguished, the first to fourth coefficient calculation units will simply be referred to as a coefficient calculation unit. Hereinafter, an operation of the coefficient calculation unit will be described.

### (Operation of First Coefficient Calculation Unit)

The frequency domain signal of the real component XI and the frequency domain signal of the imaginary component XQ are input to the first coefficient calculation unit. Each of the frequency domain signal of the real component XI and the frequency domain signal of the imaginary component XQ input to the first coefficient calculation unit is branched into a first path and a second path. In the first path, the frequency domain signal of the real component XI and the frequency domain signal of the imaginary component XQ are multiplied by the complex transfer function updated by the coefficient updating unit.

In the second path, the frequency domain signal of the real component XI and the frequency domain signal of the imaginary component XQ are converted into a frequency domain signal subjected to inversion and complex conjugation by the inversion and complex conjugation unit. Accordingly, the frequency domain signal of the real component XI input to the first coefficient calculation unit is converted into the real component inverted complex conjugation signal, and the frequency domain signal of the imaginary component XQ is converted into the imaginary component inverted complex conjugation signal.

In the first coefficient calculation unit, the real component inverted complex conjugation signal and the imaginary component inverted complex conjugation signal are multiplied by the signal based on the reception signal. Here, the signal based on the reception signal is a signal obtained on the basis of the following processing (1) to (5).
(1): Subtract the reception signal (for example, X_{Rsig}(n)) from the reference signal (for example, dₓ(n))
(2): Multiply the signal obtained by processing (1) by a frequency offset (for example, exp(−jφₓ(n)))
(3): Add zero to the signal obtained in the processing of (2) (corresponds to “zero addition” illustrated in FIG. 3)
(4): M-point inverse discrete Fourier transform or inverse fast Fourier transform (corresponds to “M-DFT” illustrated in FIG. 3) of the signal obtained in the processing of (3)
(5): Copy the frequency domain signal obtained in the processing of (4) in the frequency domain (corresponds to “folded copy” illustrated in FIG. 3)

For the reference signal (for example, dₓ(n) or d_{y}(n)), a pilot signal inserted in advance on the transmitting side, or a value temporarily determined from the reception signal (for example, X_{Rsig}(n) or Y_{Rsig}(n)), or the like is used. The processing for adding zeros illustrated in (3) is processing of adding, to the input signal, zeros in a number that is M/N times a signal length to be cut in the overlap save method described in Reference 1. In the processing of adding zeros, zeros in a number that is M/N times the signal length to be cut are continuously added to the input signal. The copy in the frequency domain illustrated in (5) is processing of copying a frequency domain signal in a line-symmetric manner with the Nyquist frequency as a reference. Copying in the frequency domain illustrated in (5) corresponds to upsampling processing in the time domain.

Although the configuration in which zero addition, M-DFT, and folded copy processing are performed is shown above, upsampling and N-DFT processing may be performed instead.

The real component inverted complex conjugation signal and the imaginary component inverted complex conjugation signal multiplied by the signal based on the reception signal are input to the coefficient updating unit. The coefficient updating unit performs processing of N-IDFT, Cut, zero addition, N-DFT, multiplication by step size μ, and addition of a value of a previous impulse response on the real component inverted complex conjugation signal and the imaginary component inverted complex conjugation signal multiplied by the signal based on the reception signal. As the step size μ, a normalized LMS (Reference 1) in which the step size is normalized by the input signal power for each frequency bin may be used.

Processing for updating the impulse response H₁ will be described as an example of the processing of the first coefficient calculation unit, and the coefficient updating unit first performs N (for example, N=256) point inverse discrete Fourier transform or inverse fast Fourier transform on a real component inverted complex conjugation signal (here, signal A1) multiplied by the signal based on the reception signal. Accordingly, the coefficient updating unit converts a frequency domain signal A1 into a time domain signal A1. Next, the coefficient updating unit performs signal extraction processing using the overlap save method on the time domain signal A1. Next, the coefficient updating unit performs processing of adding zero to the time domain signal A1 subjected to the extraction processing. Next, the coefficient updating unit multiplies the zero-added time domain signal A1 by the step size μ₁. Next, the coefficient updating unit updates the value of the impulse response H₁ by adding the value of the impulse response H₁ obtained immediately before to the time domain signal A1 multiplied by the step size μ₁.

The processing for updating the impulse response H₃ in the first coefficient calculation unit is the same as the processing described above except that the step size value is different. Further, the processing for updating the impulse responses H₅ and H₇ in the first coefficient calculation unit is the same as the processing described above except that the imaginary component inverted complex conjugation signal multiplied by the signal based on the reception signal is input to the coefficient updating unit, and that the step size value is different.

### (Operation of Second Coefficient Calculation Unit)

The real component inverted complex conjugation signal of the real component XI and the imaginary component inverted complex conjugation signal of the imaginary component XQ are input to the second coefficient calculation unit. Each of the real component inverted complex conjugation signal of the real component XI and the imaginary component inverted complex conjugation signal of the imaginary component XQ input to the second coefficient calculation unit are branched into the first path and the second path. In the first path, the real component inverted complex conjugation signal of the real component XI and the imaginary component inverted complex conjugation signal of the imaginary component XQ are multiplied by the complex transfer function updated by the coefficient updating unit.

In the second path, the real component inverted complex conjugate signal of the real component XI and the imaginary component inverted complex conjugate signal of the imaginary component XQ are converted into a frequency domain signal subjected to inversion and complex conjugate by the inversion and complex conjugate unit. Accordingly, the real component inverted complex conjugation signal of the real component XI input to the second coefficient calculation unit is converted into a frequency signal of the real component XI, and the imaginary component inverted complex conjugation signal of the imaginary component XQ is converted into the frequency domain signal of the imaginary component XQ.

In the second coefficient calculation unit, the frequency signal of the real component XI and the frequency domain signal of the imaginary component XQ are multiplied by a signal based on the above-described reception signal. However, in the signal based on the reception signal in the second coefficient calculation unit, the signal obtained in the processing of (1) is multiplied by the frequency offset exp(jφₓ(n)) as the frequency offset. The frequency signal of the real component XI and the frequency domain signal of the imaginary component XQ multiplied by the signal based on the reception signal are input to the coefficient updating unit. The coefficient updating unit performs processing of N-IDFT, Cut, zero addition, N-DFT, multiplication by step size μ, and addition of a value of a previous impulse response on the frequency signal of the real component XI and the frequency domain signal of the imaginary component XQ multiplied by the signal based on the reception signal. Since the processing performed by the coefficient updating unit is the same as the processing described in FIG. 3, description thereof will be omitted.

### (Operation of Third Coefficient Calculation Unit)

The processing performed by the third coefficient calculation unit is the same as the processing performed by the first coefficient calculation unit except that the input signal is a signal of Y-polarization, that the step size used in the coefficient updating unit is different, and that, in the generation of the signal based on the reception signal, a signal obtained by subtracting the received signal (for example, Y_{Rsig}(n)) from a reference signal (for example, d_{y}(n)) is multiplied by a frequency offset exp(jφ_{y}(n)) as a frequency offset.

### (Operation of Fourth Coefficient Calculation Unit)

The processing performed by the fourth coefficient calculation unit is the same as the processing performed by the second coefficient calculation unit except that the input signal is a signal of Y-polarization, that the step size used in the coefficient updating unit is different, and that, in generation of the signal based on the reception signal, a signal obtained by subtracting the reception signal (for example, Y_{Rsig}(n)) from a reference signal (for example, d_{y}(n)) is multiplied by a frequency offset exp(−jφ_{y}(n)) as a frequency offset.

The processing of Cut and zero addition in the coefficient updating unit corresponds to multiplication by a rectangular window function in the time domain. By changing the window function in the time domain to a cosine window and processing this as convolution in the frequency domain, it is possible to omit N-IDFT and N-DFT and to simplify N-IDFT and N-DFT.

According to the demodulated digital signal processing unit 532 configured as described above, since convolution calculation can be performed in the frequency domain, it is possible to reduce the amount of calculation. As a result, it becomes possible to realize power saving of the receiver of the digital coherent optical transmission system.

### Modification Example of First Embodiment

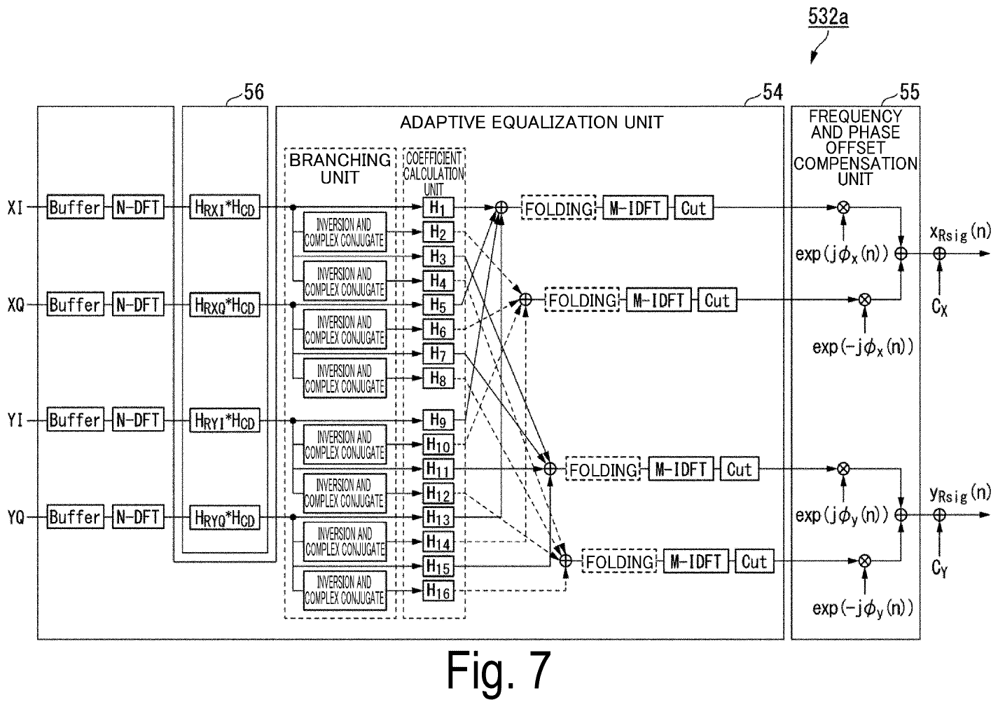

The demodulated digital signal processing unit 532 may has a configuration in which the signal processing such as frequency characteristic compensation and chromatic dispersion compensation is performed. FIG. 7 is a diagram illustrating an example of a configuration of a demodulated digital signal processing unit 532a in a modification example of the first embodiment. The demodulated digital signal processing unit 532a includes an adaptive equalization unit 54, a frequency and phase offset compensation unit 55, and a front-end correction and chromatic dispersion estimation unit 56. The demodulated digital signal processing unit 532a has a different configuration from the demodulated digital signal processing unit 532 in which the front-end correction and chromatic dispersion estimation unit 56 is included between the functional units constituting the adaptive equalization unit 54. The other configuration of the demodulated digital signal processing unit 532a is the same as that of the demodulated digital signal processing unit 532. Hereinafter, differences will be described.

The front-end correction and chromatic dispersion estimation unit 56 multiplies the frequency domain signal by the reception side device characteristics and the chromatic dispersion compensation coefficient. For example, the front-end correction and chromatic dispersion estimation unit 56 multiplies the frequency domain signal of the real component XI by a reception side device characteristic H_{RXI} and the chromatic dispersion compensation coefficient H_{CD}. The frequency domain signal of the real component XI multiplied by the reception side device characteristic H_{RXI} and the chromatic dispersion compensation coefficient H_{CD} is branched into four, two of the four branched signals are directly input to the coefficient calculation unit, and the remaining two signals are converted into frequency domain signal subjected to inversion and complex conjugation and input to the coefficient calculation unit. The subsequent processing is the same as the processing described above.

Similarly, the front-end correction and chromatic dispersion estimation unit 56 multiplies the frequency domain signal of the imaginary component XQ by the reception side device characteristic H_{RXQ} and the chromatic dispersion compensation coefficient H_{CD}. The frequency domain signal of the imaginary component XQ multiplied by the reception side device characteristic H_{RXQ} and the chromatic dispersion compensation coefficient H_{CD} is branched into four, two of the four branched signals are directly input to the coefficient calculation unit, and the remaining two signals are converted into frequency domain signal subjected to inversion and complex conjugation and input to the coefficient calculation unit.

Similarly, the front-end correction and chromatic dispersion estimation unit 56 multiplies the frequency domain signal of the real component YI by the reception side device characteristic H_{RYI} and the chromatic dispersion compensation coefficient H_{CD}. The frequency domain signal of the real component YI multiplied by the reception side device characteristic H_{RYI} and the chromatic dispersion compensation coefficient H_{CD} is branched into four, two of the four branched signals are directly input to the coefficient calculation unit, and the remaining two signals are converted into frequency domain signal subjected to inversion and complex conjugation and input to the coefficient calculation unit.

Similarly, the front-end correction and chromatic dispersion estimation unit 56 multiplies the frequency domain signal of the imaginary component YQ by the reception side device characteristic H_{RYQ} and the chromatic dispersion compensation coefficient H_{CD}. The frequency domain signal of the imaginary component YQ multiplied by the reception side device characteristic H_{RYQ} and the chromatic dispersion compensation coefficient H_{CD} is branched into four, two of the four branched signals are directly input to the coefficient calculation unit, and the remaining two signals are converted into frequency domain signal subjected to inversion and complex conjugation and input to the coefficient calculation unit.

In the front-end correction and chromatic dispersion estimation unit 56, a value obtained by multiplying the reception side device characteristics by the chromatic dispersion compensation coefficient in advance may be set, or frequency bins of the main signal and the coefficients may be shifted so that frequency offset compensation is performed.

In the configuration of the demodulated digital signal processing unit 532a, the front-end correction and chromatic dispersion estimation unit 56 may be included at a stage before the buffer.

The demodulated digital signal processing unit 532a may perform frequency offset compensation by frequency-shifting the main signal and coefficients, instead of including the front-end correction and chromatic dispersion estimation unit 56.

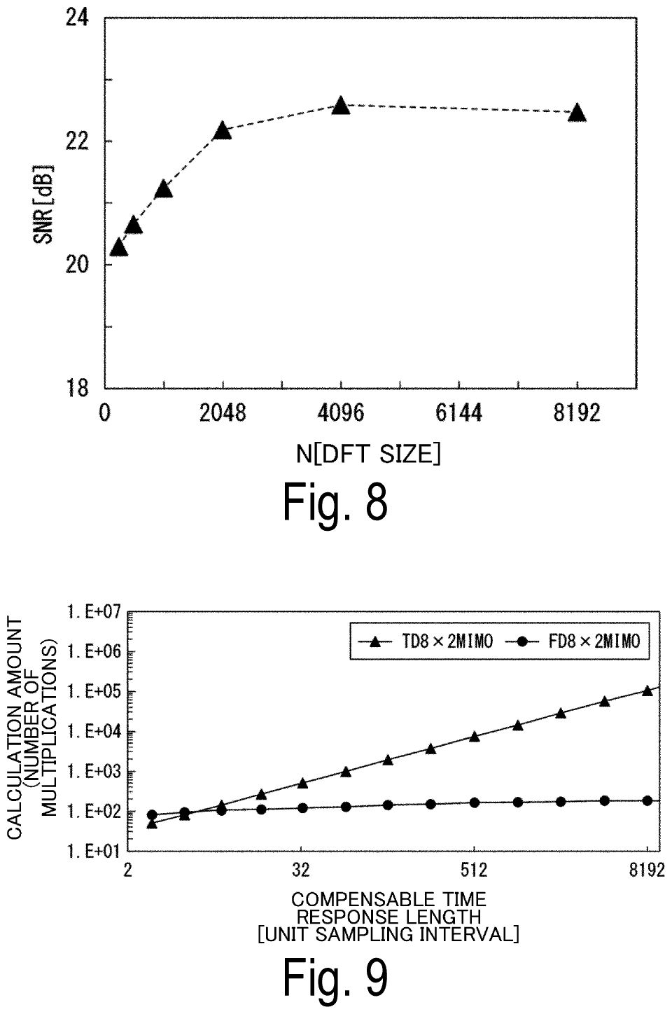

FIG. 8 is a diagram illustrating N-DFT size dependence (DFT is calculated by FFT) of a received SNR (Signal-Noise Ratio) of 128 GBaud and 256QAM (Quadrature Amplitude Modulation) according to the configuration illustrated in FIG. 7. As illustrated in FIG. 8, it can be seen that when a DFT size is increased, a compensable time response (frequency resolution) increases, and thus the received SNR (signal-to-noise ratio) is improved.

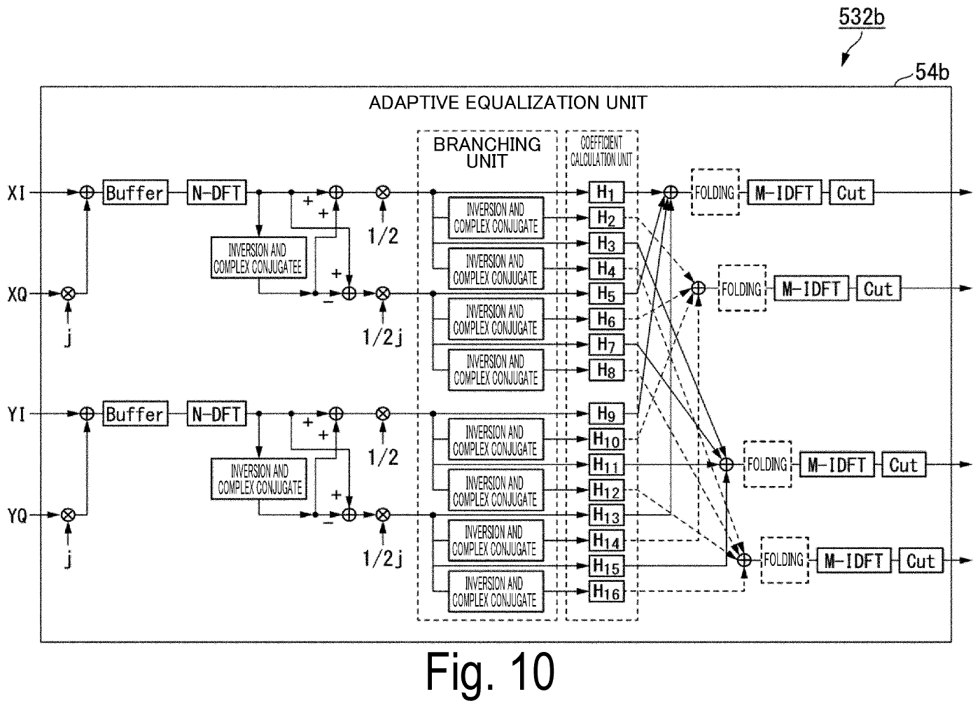

FIG. 9 is a diagram illustrating a comparison result of the number of multiplications between a configuration of the related art (for example, a configuration described in PTL 1) and the configuration illustrated in FIG. 7. In FIG. 9, an input sampling rate: 256 GSample/a, symbol rate: 128 GBaud, DFT size: N, IDFT block size: M=N/2 (DFT and IDFT are assumed to be calculations in Fast Fourier Transform (FFT) and Inverse Fast Fourier Transform (IFFT)), and an overlap amount of an overlap save method is halved (in this case, a compensable time response length is (N/2×sampling interval), and compensation performance is the same as that of the configuration of the related art having a tap length of N/2). Here, in FIG. 9, calculation amounts for a reception side device imperfection coefficient and a dispersion compensation coefficient are excluded (only calculation for an adaptive filter coefficient is considered).

The number of multiplications in fast Fourier transform is 4×(N/2)×log₂(N), the number of multiplications in fast inverse Fourier transform is 4×(N/4)×log₂(N/2), and the number of multiplications for an adaptive filter coefficient is 16×N. Under this condition, the number of symbols that can be output from one block is N/4, and thus, the number of multiplications per symbol is 2×log₂(N)+4×log₂(N/2)+64. In the configuration of the related art, since it is sufficient to consider the number of multiplications of convolution operations per symbol, the number of taps L of the adaptive filter is 16 L.

### Second Embodiment

In a second embodiment, a configuration capable of reducing the number of discrete Fourier transforms or fast Fourier transforms as compared to the first embodiment will be described. In the second embodiment, the configuration of the adaptive equalization unit among the configurations included in the demodulated digital signal processing unit is different from that in the first embodiment. Therefore, only differences between the first embodiment and the second embodiment will be described.

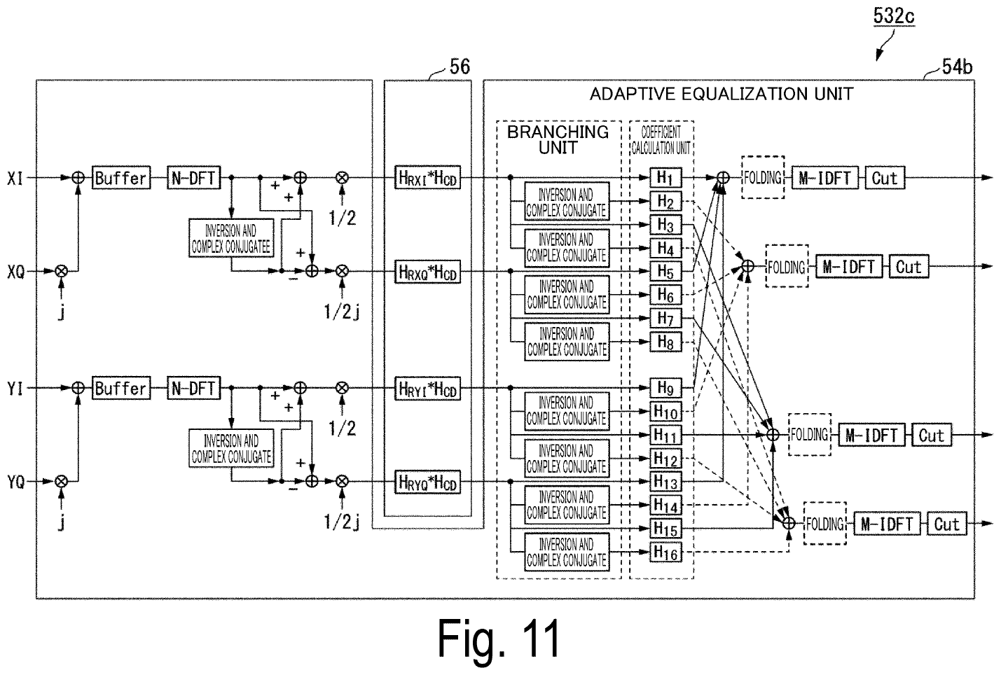

FIG. 10 is a diagram illustrating an example of the configuration of the demodulated digital signal processing unit 532b in the second embodiment. In FIG. 10, a configuration after the frequency and phase offset compensation unit 55 having the same configuration as that in the first embodiment is omitted. The adaptive equalization unit 54b of the demodulated digital signal processing unit 532b illustrated in FIG. 10 differs from the adaptive equalization unit 54 in a configuration at a stage before the branching unit. The demodulated digital signal processing unit 532b does not perform the signal processing such as frequency characteristic compensation and chromatic dispersion compensation.

The adaptive equalization unit 54b receives the real component XI and the imaginary component XQ of the reception signal of the X-polarization converted into digital signals by the ADCs 531-1 to 531-4, and the real component YI and imaginary component YQ of the reception signal of the Y-polarization. The adaptive equalization unit 54b multiplies the input imaginary component XQ by an imaginary unit j to generate an imaginary component jXQ. The adaptive equalization unit 54b adds the real component XI to the imaginary component jXQ. Accordingly, the adaptive equalization unit 54b generates the addition signal of XI+jXQ. The adaptive equalization unit 54b stores the generated addition signal in a buffer.

The adaptive equalization unit 54b performs N-point discrete Fourier transform or fast Fourier transform on the addition signal stored in the buffer (corresponding to “N-DFT” illustrated in FIG. 10). Thereby, the adaptive equalization unit 54b converts the X-polarization addition signal into a frequency domain signal.

The addition signal in the frequency domain generated by the adaptive equalization unit 54b is branched into two. One of the branched addition signals in the frequency domain is converted into a frequency domain signal subjected to inversion and complex conjugate. In the following description, the addition signal in the frequency-domain converted into a frequency domain signal subjected to inversion and complex conjugation after branching at a stage before the branching unit will be referred to as a “post-conversion addition signal in the frequency domain,” and, the addition signal in the frequency domain not converted into a frequency domain signal subjected to inversion and complex conjugation after branching will be referred to as a “pre-conversion addition signal in the frequency domain.”

Each of the pre-conversion addition signal in the frequency domain and the post-conversion addition signal in the frequency domain is branched into two, and the adaptive equalization unit 54b adds the pre-conversion addition signal in the frequency domain to the post-conversion addition signal in the frequency domain and then, multiplies a result of the addition by ½. This signal is a signal equivalent to the frequency domain signal of the real component XI in the first embodiment. Thereafter, the addition signal multiplied by ½ (the frequency domain signal of the real component XI) is branched into four by the branching unit, two of the four branched signals are directly input to the coefficient calculation unit, and the remaining two signals are converted into frequency domain signal subjected to inversion and complex conjugation and input to the coefficient calculation unit.

Further, the adaptive equalization unit 54b subtracts the post-conversion addition signal in the frequency domain from the pre-conversion addition signal in the frequency domain, and then multiplies a subtraction result by ½j. This signal is a signal equivalent to the frequency domain signal of the imaginary component XQ in the first embodiment. Thereafter, the signal multiplied by ½j (the frequency domain signal of the imaginary component) is branched into four by the branching unit, two of the four branched signals are directly input to the coefficient calculation unit, and the remaining two signals are converted into frequency domain signal subjected to inversion and complex conjugation and input to the coefficient calculation unit.

The above is processing regarding the X polarization.

Similarly, the adaptive equalization unit 54b multiplies the input imaginary component YQ by the imaginary unit j to generate an imaginary component jYQ. The adaptive equalization unit 54b adds the real component YI to the imaginary component jYQ. Accordingly, the adaptive equalization unit 54b generates an addition signal of YI+jYQ. The adaptive equalization unit 54b stores the generated addition signal in a buffer.

The adaptive equalization unit 54b performs N-point discrete Fourier transform or fast Fourier transform on the addition signal stored in the buffer (corresponding to “N-DFT” illustrated in FIG. 10). Accordingly, the adaptive equalization unit 54b converts the addition signal of the Y-polarization into a frequency domain signal.

The addition signal in the frequency domain generated by the adaptive equalization unit 54b is branched into two. One of the branched addition signals in the frequency domain is converted into a frequency domain signal subjected to inversion and complex conjugate. Each of the pre-conversion addition signal in the frequency domain and the post-conversion addition signal in the frequency domain is branched into two, and the adaptive equalization unit 54b adds the pre-conversion addition signal in the frequency domain to the post-conversion addition signal in the frequency domain and then, multiplies a result of the addition by ½. This signal is a signal equivalent to the frequency domain signal of the real component YI in the first embodiment. Thereafter, the addition signal (frequency domain signal of the real component YI) multiplied by ½ is branched into four by the branching unit, two of the four branched signals are directly input to the coefficient calculation unit, and the remaining two signals are converted into frequency domain signal subjected to inversion and complex conjugation and input to the coefficient calculation unit.

Further, the adaptive equalization unit 54b subtracts the post-conversion addition signal in the frequency domain from the pre-conversion addition signal in the frequency domain, and then multiplies a subtraction result by ½j. This signal is a signal equivalent to the frequency domain signal of the imaginary component YQ in the first embodiment. Thereafter, the signal multiplied by ½j (frequency domain signal of the imaginary component YQ) is branched into four by the branching unit, two of the four branched signals are directly input to the coefficient calculation unit, and the remaining two signals are converted into frequency domain signal subjected to inversion and complex conjugation and input to the coefficient calculation unit.

The above is processing regarding the Y polarization.

In the adaptive equalization unit 54b, the processing after the coefficient calculation unit is the same as in the first embodiment.

According to the demodulated digital signal processing unit 532b in the second embodiment configured as described above, it is possible to reduce the number of discrete Fourier transforms or fast Fourier transforms as compared to the first embodiment. Specifically, the demodulated digital signal processing unit 532 in the second embodiment performs discrete Fourier transform or fast Fourier transform after adding the real component XI to the imaginary component XQ. This eliminates the need to perform discrete Fourier transform or fast Fourier transform on each of the real component XI and the imaginary component XQ. Therefore, it is possible to reduce the number of discrete Fourier transforms or fast Fourier transforms as compared to the first embodiment.

### Modification Example of Second Embodiment

The adaptive equalization unit 54b may be configured to perform the signal processing such as frequency characteristic compensation and chromatic dispersion compensation, as in the first embodiment. FIG. 11 is a diagram illustrating an example of the configuration of the demodulated digital signal processing unit 532c in a modification example of the second embodiment. In FIG. 11, the configuration after the frequency and phase offset compensation unit 55 having the same configuration as the first embodiment is omitted.

The demodulated digital signal processing unit 532c includes an adaptive equalization unit 54b, a frequency and phase offset compensation unit 55 (omitted in FIG. 11), and the front-end correction and chromatic dispersion estimation unit 56. The demodulated digital signal processing unit 532c differs from the configuration illustrated in FIG. 10 in that the front-end correction and chromatic dispersion estimation unit 56 is included between the functional units constituting the adaptive equalization unit 54b. The other configuration of the demodulated digital signal processing unit 532c is the same as the configuration illustrated in FIG. 10. Hereinafter, differences will be described.

The front-end correction and chromatic dispersion estimation unit 56 multiplies the addition signal (frequency domain signal of the real component XI) multiplied by ½ by the reception side device characteristic H_{RXI} and the chromatic dispersion compensation coefficient H_{CD}. The frequency domain signal of the real component XI multiplied by the reception side device characteristic H_{RXI} and the chromatic dispersion compensation coefficient H_{CD} is branched into four by the branching unit, two of the four branched signals are directly input to the coefficient calculation unit, and the remaining two signals are converted into frequency domain signal subjected to inversion and complex conjugation and input to the coefficient calculation unit. The subsequent processing is the same as the processing described above.

Similarly, the front-end correction and chromatic dispersion estimation unit 56 multiplies the addition signal (signal in the frequency domain of the imaginary component XQ) multiplied by ½j by the reception side device characteristic H_{RXQ} and the chromatic dispersion compensation coefficient H_{CD}. The frequency domain signal of the imaginary component XQ multiplied by the reception side device characteristic H_{RXQ} and the chromatic dispersion compensation coefficient H_{CD} is branched into four by the branching unit, two of the four branched signals are directly input to the coefficient calculation unit, and the remaining two signals are converted into frequency domain signal subjected to inversion and complex conjugation and input to the coefficient calculation unit.

Similarly, the front-end correction and chromatic dispersion estimation unit 56 multiplies the addition signal (the frequency domain signal of the real component YI) multiplied by ½ by the reception side device characteristic H_{RYI} and the chromatic dispersion compensation coefficient H_{CD}. The frequency domain signal of the real component YI multiplied by the reception side device characteristic H_{RYI} and the chromatic dispersion compensation coefficient H_{CD} is branched into four by the branching unit, two of the four branched signals are directly input to the coefficient calculation unit, and the remaining two signals are converted into frequency domain signal subjected to inversion and complex conjugation and input to the coefficient calculation unit.

Similarly, the front-end correction and chromatic dispersion estimation unit 56 multiplies the addition signal (signal in the frequency domain of the imaginary component YQ) multiplied by ½j by the reception side device characteristic H_{RYQ} and the chromatic dispersion compensation coefficient H_{CD}. The frequency domain signal of the imaginary component YQ multiplied by the reception side device characteristic H_{RYQ} and the chromatic dispersion compensation coefficient He is branched into four by the branching unit, two of the four branched signals are directly input to the coefficient calculation unit, and the remaining two signals are converted into frequency domain signal subjected to inversion and complex conjugation and input to the coefficient calculation unit.

The demodulated digital signal processing unit 532c may perform the frequency offset compensation by frequency-shifting the main signal and coefficients, instead of including the front-end correction and chromatic dispersion estimation unit 56.

### Third Embodiment

In a third embodiment, a configuration of the adaptive equalization unit among configurations included in the demodulated digital signal processing unit is different from that in the second embodiment. Therefore, differences from the second embodiment will be described.

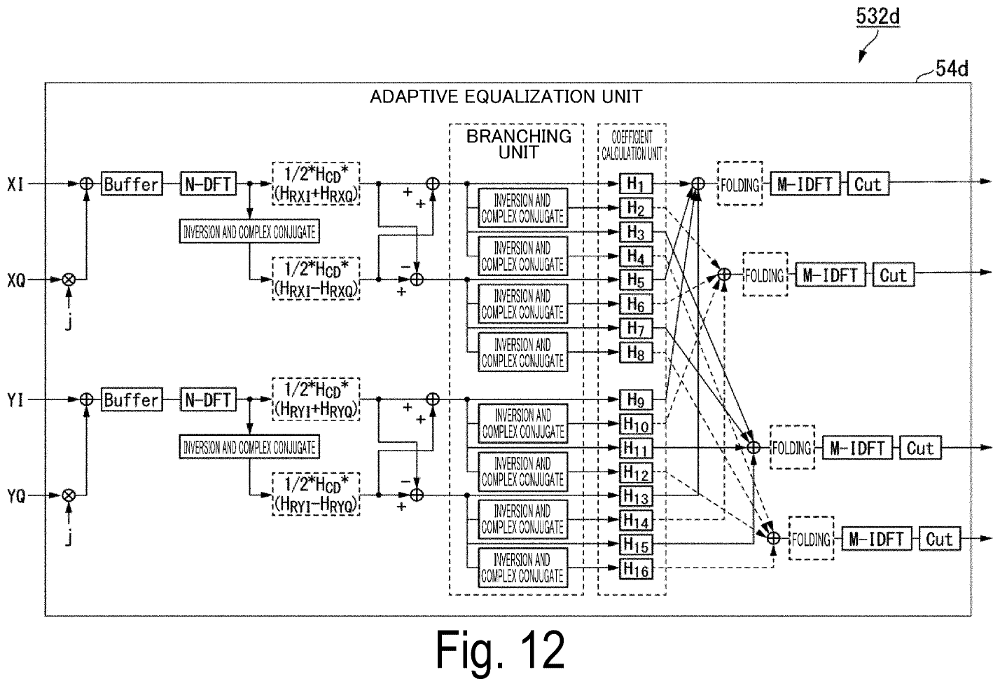

FIG. 12 is a diagram illustrating an example of a configuration of the demodulated digital signal processing unit 532d in the third embodiment. In FIG. 12, a configuration after the frequency and phase offset compensation unit 55, which has the same configuration as the second embodiment (particularly the demodulated digital signal processing unit 532c illustrated in FIG. 11) is omitted. The demodulated digital signal processing unit 532d includes an adaptive equalization unit 54d and a frequency and phase offset compensation unit 55 (omitted in FIG. 12).

The adaptive equalization unit 54d multiplies the pre-conversion addition signal in the frequency domain of the X polarization by a value (½×H_{CD}) that is a sum of the reception side device characteristic H_{RXI} and the reception side device characteristic H_{RXQ}.

Similarly, the adaptive equalization unit 54d multiplies the converted addition signal in the frequency domain of the X polarization by a value (½×H_{CD}) obtained by subtracting the reception side device characteristic H_{RXQ} from the reception side device characteristic H_{RXI}. Each of the pre-conversion addition signal in the frequency domain of the X-polarization multiplied by ½×H_{CD}* and the post-conversion addition signal in the frequency domain of the X-polarization multiplied by ½×H_{CD}* is branched into two.

The adaptive equalization unit 54d adds the pre-conversion addition signal in the frequency domain of the X-polarization multiplied by ½×H_{CD} to the post-conversion addition signal in the frequency domain of the X-polarization multiplied by ½×H_{CD}. Thereafter, this addition signal is branched into four signals by the branching unit, two of the four branched signals are directly input to the coefficient calculation unit, and the remaining two signals are converted into frequency domain signal subjected to inversion and complex conjugation and input to the coefficient calculation unit.

Further, the adaptive equalization unit 54d subtracts the pre-conversion addition signal in the frequency domain of the X-polarization multiplied by ½×H_{CD}″ from the post-conversion addition signal in the frequency domain of the X-polarization multiplied by ½×H_{CD}. Thereafter, this subtracted signal is branched into four signals by the branching unit, two of the four branched signals are directly input to the coefficient calculation unit, and the remaining two signals are converted into frequency domain signal subjected to inversion and complex conjugation and input to the coefficient calculation unit.

The above is processing regarding the X polarization.

The adaptive equalization unit 54d multiplies the pre-conversion addition signal in the frequency domain of the Y polarization by a value (½× H_{CD}*) obtained by adding the reception side device characteristic H_{RYI} and the reception side device characteristic H_{RYQ}. Similarly, the adaptive equalization unit 54d multiplies the converted addition signal in the frequency domain of the Y polarization by the value (½×H_{CD}*) obtained by subtracting the reception side device characteristic H_{RYQ} from the reception side device characteristic H_{RYI}. Each of a pre-conversion addition signal in the frequency domain of the Y polarization multiplied by ½× H_{CD}″ and a post-conversion addition signal in the frequency domain of the Y polarization multiplied by ½× H_{CD}* is branched into two.

The adaptive equalization unit 54d adds the pre-conversion addition signal in the frequency domain of the Y polarization multiplied by ½× H_{CD}* to the post-conversion addition signal in the frequency domain of the Y polarization multiplied by ½×H_{CD}*. Thereafter, this addition signal is branched into four signals by the branching unit, two of the four branched signals are directly input to the coefficient calculation unit, and the remaining two signals are converted into frequency domain signal subjected to inversion and complex conjugation and input to the coefficient calculation unit.

Further, the adaptive equalization unit 54d subtracts the pre-conversion addition signal in the frequency domain of the Y polarization multiplied by ½×H_{CD} from the post-conversion addition signal in the frequency domain of the Y polarization multiplied by ½×H_{CD}*. Thereafter, this subtracted signal is branched into four signals by the branching unit, two of the four branched signals are directly input to the coefficient calculation unit, and the remaining two signals are converted into frequency domain signal subjected to inversion and complex conjugation and input to the coefficient calculation unit.

The above is processing regarding the Y polarization.

In the adaptive equalization unit 54d, the processing after the coefficient calculation unit is the same as in the second embodiment.

According to the demodulated digital signal processing unit 532d in the third embodiment configured as described above, it is possible to reduce the number of discrete Fourier transforms or fast Fourier transforms as compared with that in the first embodiment, as an embodiment different from the second embodiment. In the configuration of the demodulated digital signal processing unit 532d in the third embodiment, it is possible to reduce bit precision when H_{RXI}−H_{RXQ} and H_{RYI}−H_{RYQ} are small.

### Modification Example of Third Embodiment

The demodulated digital signal processing unit 532d may perform the frequency offset compensation by frequency-shifting the main signal and coefficients at a stage after the N-DFT and before the branching unit.

### Modification Example Common to First to Third Embodiments

In each of the above embodiments, a configuration that performs wavelength division multiplexing in addition to polarization division multiplexing may be combined. The following configuration is different from the digital coherent optical transmission system 1 illustrated in FIG. 1 configured in this way.

The transmitter 10 further includes transmission units 100 as many as the number of wavelength division multiplexing (WDM) channels. For example, when the number of WDM channels is 10, the transmitter 10 includes 10 transmission units 100. The respective transmission units 100 output optical signals with different wavelengths. A WDM multiplexer, an optical fiber transmission line 30, and a WDM demultiplexer are included between the transmitter 10 and the receiver 50. The WDM multiplexer multiplexes the optical signals output from the respective transmission units 100 and outputs a multiplexed optical signal to the optical fiber transmission line 30. The WDM demultiplexer demultiplexes the optical signal transmitted through the optical fiber transmission line 30 according to wavelengths. The receiver 50 further includes reception units 500 as many as the number of WDM channels. For example, when the number of WDM channels is 10, the receiver 50 includes 10 reception units 500. Each reception unit 500 receives the optical signal demultiplexed by the WDM demultiplexer 40. The wavelengths of the optical signals received by the respective reception units 500 are different. The processing executed in the reception unit 500 is similar to the processing described above.

In each of the above embodiments, when N=M, the folding processing in the adaptive equalization units 54, 54b, and 54d may not be performed.

Some of the functional units of the receiver 50 in the embodiment described above may be realized by a computer. In this case, a program for realizing this function may be recorded in a computer-readable recording medium, and the program recorded in this recording medium may be read into a computer system and executed. The “computer system” referred to here includes hardware such as an OS and peripheral apparatuses.

Further, the “computer-readable recording medium” includes a portable medium such as a flexible disk, magneto-optical disk, a read only memory (ROM) and a CD-ROM, and various storage apparatuses such as a hard disk built into a computer system. Further, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system serving as a server or a client in such a case. Further, the program may be a program for realizing some of the above-described functions, may be a program capable of realizing the above-described functions in a combination with a program already recorded on the computer system, or may be a program realized using hardware such as a field programmable gate array (FPGA).

Although the embodiments of the present invention have been described above in detail with reference to the drawings, a specific configuration is not limited to these embodiments, and includes designs within the scope of the gist of the present invention.

### INDUSTRIAL APPLICABILITY

The present invention is applicable to a technology for receiving a single carrier polarization-multiplexed signal in a digital coherent optical transmission.

### REFERENCE SIGNS LIST

1 Digital coherent optical transmission system
10 Transmitter
30 Optical fiber transmission line
31 Optical amplifier
50 Receiver
54, 54b, 54d Adaptive equalization unit
55 Frequency and phase offset compensation unit
56 Front end correction and chromatic dispersion estimation unit
100 Transmission unit
110 Digital signal processing unit
111 Encoding unit
112 Mapping unit
113 Training signal insertion unit
114 Frequency conversion unit
115 Waveform shaping unit
116 Pre-equalization unit
117-1 to 117-4 Digital-analog converter
120 Modulator driver
121-1 to 121-4 Amplifier
130 Light source
140 Integrated module
141-1, 141-2 IQ modulator
142 Polarization synthesis unit
500 Reception unit
510 Local oscillation light source
520 Optical front-end
521 Polarization separation unit
522-1, 522-2 Optical 90 degree optical hybrid coupler
523-1 to 523-4 BPD
524-1 to 524-4 Amplifier
530 Digital signal processing unit
531-1 to 531-4 Analog-to-digital converter
532, 532a, 532b, 532c, 532d Demodulated digital signal processing unit
533 Demapping unit
534 Decoding unit

1. A signal processing method comprising:
converting a real component and an imaginary component of each polarization of a polarization multiplexed reception signal into a frequency domain signal;
receiving, as input signals, the frequency domain signal of the real component and the frequency domain signal of the imaginary component of each polarization, and a post-conversion frequency domain signal obtained by performing frequency inversion on a frequency axis on the frequency domain signal of the real component and the frequency domain signal of the imaginary component of each polarization and performing complex conjugation;
performing, for each polarization, first equalization processing for multiplying the frequency domain signal of the real component and the frequency domain signal of the imaginary component of each polarization included in the input signal by a complex transfer function, adding results, and performing an inverse transform from the frequency domain signal to the time domain signal, and second equalization processing for multiplying the post-conversion frequency domain signal of the real component and the post-conversion frequency domain signal of the imaginary component of each polarization included in the input signal by a complex transfer function, adding results, and performing an inverse transform from the frequency domain signal to the time domain signal; and
for each polarization, performing phase rotation for frequency offset compensation on the time domain signal converted in the first equalization processing to generate a first addition signal, performing phase rotation opposite to the phase rotation for frequency offset compensation on the time domain signal converted by the second equalization processing to generate a second addition signal, and adding or subtracting a transmitted data bias correction signal to or from a signal obtained by adding the first addition signal to the second addition signal.

2. A signal processing method comprising:
performing imaginary unit multiplication processing for multiplying the imaginary component of each polarization of the polarization multiplexed reception signal by an imaginary unit j, and then, performing addition processing of adding the imaginary component multiplied by the imaginary unit j to the real component of each polarization of the polarization multiplexed reception signal;
converting a signal after processing for adding the imaginary component multiplied by the imaginary unit j to the real component into a frequency domain signal;
receiving, as input signals, the calculated frequency domain signal after the calculation has been performed on the frequency domain signal of each polarization, and a post-conversion calculated frequency domain signal after calculation is performed on a post-conversion frequency domain signal obtained by performing frequency inversion on a frequency axis on the frequency domain signal of each polarization and performing complex conjugate;
performing, for each polarization, first equalization processing for multiplying the calculated frequency domain signal of the real component and the calculated frequency domain signal of the imaginary component of each polarization included in the input signal by a complex transfer function, adding results, and performing inverse transform from the frequency domain signal to the time domain signal, and second equalization processing for multiplying the post-conversion calculated frequency domain signal of the real component and the post-conversion calculated frequency domain signal of the imaginary component of each polarization included in the input signal by a complex transfer function, adding results, and performing inverse transform from the frequency domain signal to the time domain signal; and
for each polarization, performing phase rotation for frequency offset compensation on the time domain signal converted by the first equalization processing to generate a first addition signal, performing phase rotation opposite to the phase rotation for frequency offset compensation on the time domain signal converted in the second equalization processing to generate a second addition signal, and adding or subtracting a transmitted data bias correction signal to or from a signal obtained by adding the first addition signal to the second addition signal.

3. The signal processing method according to claim 2,
wherein the performing include, for each polarization, first signal processing for branching the frequency domain signal into a first path and a second path, adding the frequency domain signal branched to the first path to the frequency domain signal branched to the second path and subjected to frequency inversion and complex conjugation, and then multiplying a result of the addition by ½, and second signal processing for subtracting the frequency domain signal branched to the second path and subjected to frequency inversion and complex conjugation from the frequency domain signal branched to the first path, and then multiplying a result of the subtraction by ½j, and then generating the input signal.

4. The signal processing method according to claim 2,
wherein the performing include, for each polarization, first signal processing for branching the frequency domain signal into a first path and a second path and adding a frequency domain signal after compensation of frequency characteristics and chromatic dispersion compensation of the frequency domain signal branched to the first path to the frequency domain signal branched to the second path, subjected to frequency inversion and complex conjugation, and subjected to compensation of frequency characteristics and chromatic dispersion compensation, and second signal processing for subtracting the frequency domain signal branched to the second path, subjected to frequency inversion and complex conjugation, and subjected to compensation of frequency characteristics and chromatic dispersion compensation from the frequency domain signal after compensation of frequency characteristics and chromatic dispersion compensation of the frequency domain signal branched to the first path, and then generating the input signal.

5. A signal processing apparatus comprising:
a frequency converter configured to convert a real component and an imaginary component of each polarization of a polarization multiplexed reception signal into a frequency domain signal;
a signal inputter configured to receive, as input signals, the frequency domain signal of the real component and the frequency domain signal of the imaginary component of each polarization, and a post-conversion frequency domain signal obtained by performing frequency inversion on a frequency axis on the frequency domain signal of the real component and the frequency domain signal of the imaginary component of each polarization and performing complex conjugation;
an equalizer configured to perform, for each polarization, first equalization processing for multiplying the frequency domain signal of the real component and the frequency domain signal of the imaginary component of each polarization included in the input signal by a complex transfer function, adding results, and performing an inverse transform from the frequency domain signal to the time domain signal, and second equalization processing for multiplying the post-conversion frequency domain signal of the real component and the post-conversion frequency domain signal of the imaginary component of each polarization included in the input signal by a complex transfer function, adding results, and performing an inverse transform from the frequency domain signal to the time domain signal; and
a compensator configured to, for each polarization, perform phase rotation for frequency offset compensation on the time domain signal converted in the first equalization processing to generate a first addition signal, perform phase rotation opposite to the phase rotation for frequency offset compensation on the time domain signal converted in the second equalization processing to generate a second addition signal, and add or subtract a transmitted data bias correction signal to or from a signal obtained by adding the first addition signal to the second addition signal.

6. (canceled)

7. (canceled)
